(19) United States
(12) Patent Application Publication
(10) Pub. No.: US 2012/0246385 A1
(43) Pub. Date: Sep. 27, 2012

(54) EMULATING SPI OR 12C PROM/EPROM/EEPROM USING FLASH MEMORY OF MICROCONTROLLER

(75) Inventors: Kayalvizhi Dhandapani, Suwanee, GA (US); Clas Gerhard Sivertsen, Lilburn, GA (US)

(73) Assignee: AMERICAN MEGATRENDS, INC., Norcross, GA (US)

(21) Appl. No.: 13/069,107

(22) Filed: Mar. 22, 2011

(51) Int. Cl. G06F 12/02

(52) U.S. Cl. 711/103; 711/E12.008

(57) ABSTRACT

In one aspect, a microcontroller is disclosed. In one embodiment, the microcontroller includes a system memory that has an erasable memory of a first type, with a first storage partition and a second, different storage partition. The system memory also has a random access memory (RAM). The microcontroller further includes a network interface that is configured to communicate management commands over a communications link, and a programmable processor that is operatively connected to the system memory and the network interface. The communications link includes an interface bus and is configured for one or more of I2C, SPI, and system management bus communications. The programmable processor is programmed to perform functions that include receiving a first management command configured for the erasable memory of the first type, causing the second storage partition of the erasable memory of the first type to emulate a second type of erasable memory, and receiving a second management command configured for the second type of erasable memory.

### FIELD OF THE INVENTION

The present invention generally relates to a microcontroller having a flash memory, and more particularly to emulating SPI or I2C PROM/EPROM/EEPROM using the flash memory.

### BACKGROUND OF THE INVENTION

A conventional computing system may include a backplane having a backplane controller and a separate programmable memory component such as a PROM, EPROM, or EEPROM attached to the backplane. The backplane controller and programmable memory component may be connected to a host computer using an interface bus. An original equipment manufacturer (OEM) may program the programmable memory component at manufacturing time to include device-specific information related to production date, type, serial number, lot code, date code, and/or firmware revision associated with a device in the system. Each of the backplane controller component and separate programmable memory component requires a certain amount of valuable physical space in a computing system, and each has an associated component cost.

Therefore, a heretofore unaddressed need still exists in the art to address the aforementioned deficiencies and inadequacies.

### SUMMARY OF THE INVENTION

In one aspect, the present invention relates to a microcontroller. According to one embodiment, the microcontroller includes a system memory having an erasable memory of a first type, with a first storage partition and a second, different storage partition. The system memory also has a random access memory (RAM). The microcontroller further includes a network interface that is configured to communicate management commands over a communications link, and a programmable processor that is operatively connected to the system memory and the network interface. The communications link includes an interface bus and is configured for one or more of I2C, SPI, and system management bus communications. The programmable processor is programmed to perform functions that include receiving a first management command configured for the erasable memory of the first type, causing the second storage partition of the erasable memory of the first type to emulate a second type of erasable memory, and receiving a second management command configured for the second type of erasable memory.

In one embodiment, the programmable processor is further programmed to respond to the first management command and/or second management command, and to send the respective response over the communications link, via the network interface. In one embodiment, the system memory, network interface, and programmable processor are operatively coupled to a storage backplane, and the network interface is communicatively connected to a management controller that is operative to generate the first management command and the second management command. The management controller is further operative to transmit the generated first management command and second management command to the programmable processor, and to receive a response from the programmable processor in response to the first management command and/or the second management command, over the communications link. In one embodiment, the erasable memory of the first type is a flash memory and the second type of erasable memory is an EEPROM. In this embodiment, the second storage partition of the erasable memory of the first type is operative to store data configured for an EEPROM. In an alternative embodiment, the second type of erasable memory is a SPI flash device and the second storage partition of the erasable memory of the first type is operative to store data configured for an SPI flash device.

In one embodiment, the programmable processor is programmed to, in response to a management command to write updated data to the second type of erasable memory, read out the data stored in the second storage partition of the erasable memory of the first type and write the read-out data into the RAM. The programmable processor is also programmed to write the updated data into the RAM.

In one embodiment, the programmable processor is programmed to read out the data from the RAM and write the read-out data into the second storage partition of the erasable memory of the first type, such as to replace previously stored data.

In one embodiment, the programmable processor is programmed to, in response to a received management command to read data from the second type of erasable memory, read the data stored in the RAM including the updated data.

In another aspect, the present invention relates to a microcontroller operating as a backplane controller. The microcontroller is in a system that includes a baseboard with a baseboard management controller (BMC) and a storage backplane. The BMC is communicatively connected to the storage backplane via a communications link and is operative to communicate management commands over the communications link. The management commands are configured for an erasable memory of a first type and are also configured for a second, different type of erasable memory. According to one embodiment, the microcontroller includes a system memory that has an erasable memory of a first type. The erasable memory of the first type has a first storage partition and a second, different storage partition. The system memory also includes a RAM. In this embodiment, the microcontroller further includes a network interface that is operative to receive management commands from the BMC and send responses to the management commands to the BMC over the communications link. The microcontroller further includes a programmable processor that is operatively connected to the system memory and the network interface. The programmable processor is programmed to perform functions that include receiving a first management command from the BMC over the communications link. The first management command is configured for the erasable memory of the first type. The programmable processor is further programmed to perform the function of causing the second storage partition of the erasable memory of the first type to emulate the second type of erasable memory, and the function of receiving a second management command from the BMC over the communications link. The second management command is configured for the second type of erasable memory.

In one embodiment, the communications link includes an interface bus and is configured for one or more of I2C, SPI, and system management bus communications.

In one embodiment, the programmable processor is further programmed to generate a response to the first management command and/or the second management command, and to send the respective response to the BMC over the communications link, via the network interface.

In one embodiment, the system memory, network interface, and programmable processor are operatively coupled to the storage backplane.

In one embodiment, the BMC is operative to generate the management commands, transmit the first management command and second management command to the programmable processor, and receive a response from the programmable processor in response to at least one of the first management command and the second management command, over the communications link.

In one embodiment, the programmable processor is programmed to perform the function of, in response to a management command to write updated data to the second type of erasable memory, reading out the data stored in the second storage partition of the erasable memory of the first type and writing the read-out data into the RAM. The programmable processor is programmed to perform the function of writing the updated data into the RAM.

In one embodiment, the programmable processor is programmed to perform the function of reading out the data from the RAM, and the function or writing the read-out data into the second storage partition of the erasable memory of the first type, such as to replace previously stored data.

In one embodiment, the programmable processor is programmed to perform the function of, in response to a received management command to read data from the second type of erasable memory, reading the data stored in the RAM including the updated data.

In yet another aspect, the present invention relates to a computer-readable medium. According to one embodiment, instructions are stored on the computer-readable medium. The instructions, when executed by a programmable processor of a microcontroller that includes a network interface configured to communicate management commands over a communications link, a system memory with an erasable memory of a first type having a first storage partition and a second, different storage partition, and a random access memory (RAM), cause the microcontroller to perform functions that include receiving a first management command configured for the erasable memory of the first type, causing the second storage partition of the erasable memory of the first type to emulate the second type of erasable memory, and receiving a second management command configured for the second type of erasable memory.

In one embodiment, the instructions, when executed by the programmable processor, cause the microcontroller to generate a response to at least one of the first management command and second management command and send the respective response over the communications link, via the network interface. In one embodiment, the communications link includes an interface bus and is configured for one or more of I2C, SPI, and system management bus communications.

Practicing various embodiments of the present invention disclosed herein may provide for cost savings and less required physical space in a computing system, while still permitting the functions of a backplane controller and programmable memory component to be performed.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment, and wherein:

FIG. 1 schematically shows a computing system having a host bus adapter (HBA), storage backplane with backplane controller, and baseboard management controller for performing functions according to one or more embodiments of the present invention;

FIG. 2 schematically shows a backplane controller for performing functions according to one or more embodiments of the present invention;

FIG. 3 schematically shows a system memory according to one embodiment of the present invention;

FIG. 4 schematically shows a microcontroller with a first communications configuration, according to one embodiment of the present invention;

FIG. 5 schematically shows a microcontroller with a second communications configuration, according to one embodiment of the present invention;

FIG. 6 is a flow chart illustrating operational steps of a computer-implemented method according to one embodiment of the present invention; and

FIG. 7 schematically shows a computing environment for performing functions according to one or more embodiments of the present invention.

### DETAILED DESCRIPTION OF THE INVENTION

The present invention is more particularly described in the following examples that are intended as illustrative only since numerous modifications and variations therein will be apparent to those skilled in the art. Various embodiments of the present invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

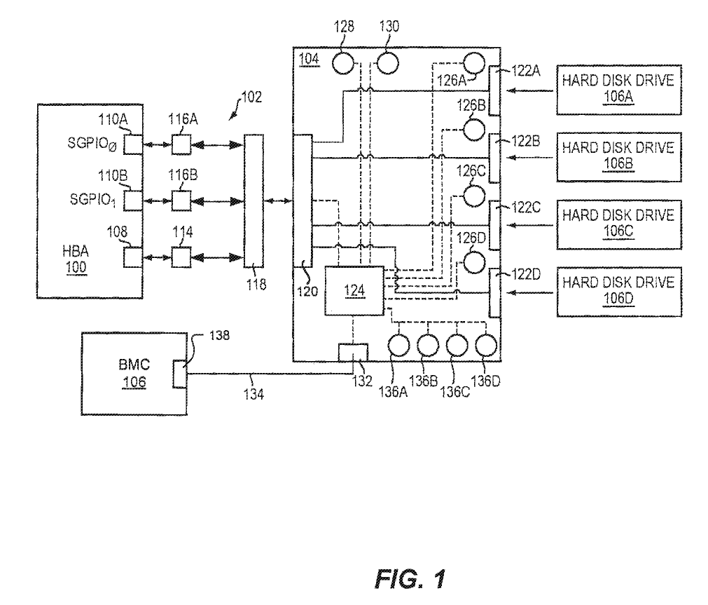

The description will be made as to the embodiments in conjunction with the accompanying drawings in FIGS. 1-7. Referring now to FIG. 1, a block diagram illustrates aspects of a host bus adapter (HBA) 100, storage backplane 104, and backplane controller 124 according to various embodiments of the present invention. An HBA 100 having one or more ports 108, 110A, 110B may be utilized in conjunction with a computing system. According to various embodiments of the present invention, the HBA 100 may support SATA mass storage devices, SAS mass storage devices, or some other type of interface for mass storage.

According to various embodiments of the present invention, different physical interfaces may be utilized by the HBA 100 to exchange enclosure management data between the HBA 100 and the storage backplane 104. For instance, an SAS compatible HBA may be equipped with one or more serial general purpose input/output (SGPIO) interfaces. As another example, a SATA compatible HBA may provide a control or management bus to exchange management data between the storage backplane 104 and the HBA 100 or a baseboard management controller (BMC). An HBA 100 equipped with SGPIO may provide SGPIO ports 116A, 116B for making appropriate connections to the storage backplane 104.

An I2C port may be available on a BMC to communicate with the storage backplane 104. It should be appreciated that the particular physical interfaces described herein for exchanging management information with the backplane are merely illustrative and that any physical communications link suitable for transmitting management data may be utilized with the various embodiments of the present invention. The HBA 100 may also support multiple enclosure management interfaces and protocols, such as I2C and SGPIO, multiple interfaces of the same type, or some custom enclosure management bus.

An HBA 100 may also be configured to support a particular protocol by upgrading the firmware of the HBA 100, or by using host-side applications, command line utilities, or configuration monitors. These operations may involve a direct interface, such as a serial port interface, to the HBA 100. These access and configuration approaches may also be used to change or otherwise configure specific instructions or commands that may be sent to the storage backplane 104.

One or more cables may be utilized to connect the SGPIO ports 110A, 110B of the HBA 100 to the storage backplane 104. In particular, individual cables may be utilized to connect the ports 110A, 110B to the storage backplane 104. Alternatively, a multilane cable 102 may be utilized to connect the individual ports on the HBA 100 to a single multilane connector 120 on the storage backplane 104. It should also be appreciated that HBAs with other port configurations may be utilized. Alternatively, the storage backplane 104 may be configured for use with fewer or more drives.

When the HBA 100 comprises a SAS-compatible HBA and includes SGPIO ports 110A, 110B, the multilane cable 102 may include appropriate connectors 116A, 116B for connecting to the SGPIO ports 110A, 110B. The multilane connector 118 is also appropriately configured for passing the side-band signals from the SGPIO ports 110A, 110B to an appropriate portion of the multilane connector 120 on the storage backplane 104. When the HBA 100 comprises a SATA-compatible HBA and I2C is utilized, an appropriate I2C cable 134 may be utilized for connecting a BMC to the I2C port 132. The SGPIO signals may be routed between the multilane connector 120 and backplane controller 124 associated with the storage backplane 104. The I2C signals may also be routed to the backplane controller 124. According to various embodiments of the present invention, the storage backplane 104 and the backplane controller 124 may be configured to receive enclosure management information on multiple interfaces to thereby support the use of various types and configurations of the HBA.

The storage backplane 104 can provide connectors 122A-122D for interfacing with one or more mass storage devices, such as hard disk drives 106A-106D. According to various embodiments of the present invention, the storage backplane 104 may be mounted within an enclosure such that the hard disk drives 106A-106D can slide into slots within the enclosure. Aligned within such enclosure slots, the hard disk drives 106A-106D may mate directly with the appropriate connector 122A-122D. The storage backplane 104 may provide circuitry for routing signals between the connectors 122A-122D and the appropriate portions of the multilane connector 120. In this manner, the storage backplane 104 can support communication between then HBA 100 and the connected hard disk drives 106A-106D. According to various embodiments of the present invention, the connectors 122A-122D may comprise receptacle connectors for receiving a SAS or SATA mass storage device.

The storage backplane 104 and backplane controller 124 may provide a number of management functions. The backplane controller 124 may be configured to receive management data via various physical interfaces, such as I2C and SGPIO. The backplane controller 124 may be configured to perform various management functions in response to receiving this data. For instance, the backplane controller 124 may receive data from the HBA 100 instructing it to illuminate one of the LEDs 126A-126D for locating a particular one of the hard disk drives 106A-106D. The backplane controller 124 may also illuminate the LEDs 126A-126D to indicate activity on the hard disk drives 106A-106D, or to indicate that one of the hard disk drives 106A-106D is being rebuilt. The LEDs 136A-136D may also be illuminated by the backplane controller 124 to indicate that one of the hard disk drives 106A-106D has failed. LEDs 128, 130 may also be illuminated to provide a global indication that one of the hard disk drives 106A-106D is active or has failed, or that a hard disk drive connected to another connected backplane is active or has failed. Various other LED configurations or status indicators may also be supported by the backplane controller 124.

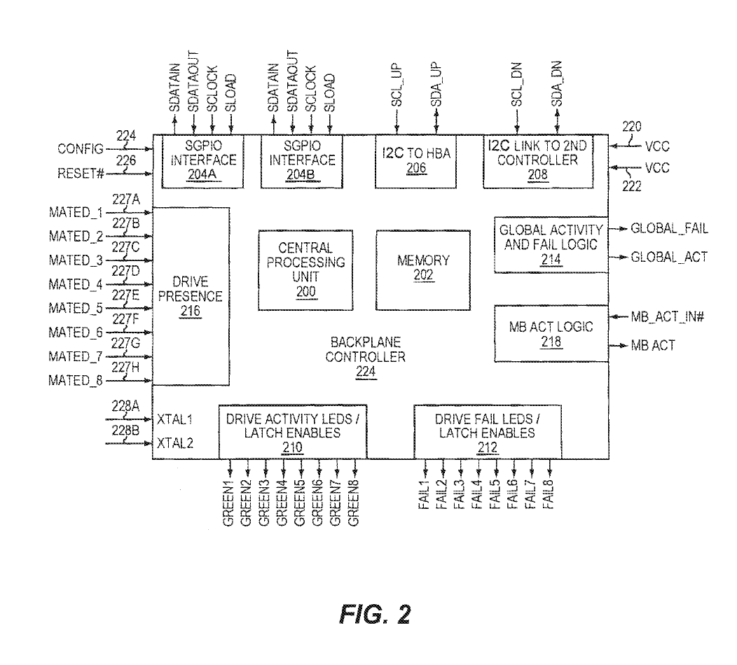

The backplane controller 124 may provide information to the HBA 100. For instance, the backplane controller 124 may provide data to the HBA 100 indicating whether a particular drive is mated to the enclosure management backplane 104. Additional details regarding the configuration and operation of the backplane controller 124 are provided below with respect to FIG. 2.

The storage backplane 104 can provide various state indicators, such as LEDs 126A-126D, LEDs 136A-136D, LED 128, and LED 130. It should be appreciated that although these state indicators have been illustrated and described herein primarily as LEDs, other types of visual, audible, or haptic indicators may be utilized to provide indications of mass storage device state and status to a user. Providing a status indication may include illuminating or activating an indicator, terminating or extinguishing an indicator, flashing, or otherwise modulating, an indicator, or any combination thereof.

Referring to FIG. 2, a functional block diagram illustrates aspects of a backplane controller 224 according to various embodiments of the present invention. According to various embodiments of the present invention, the backplane controller 224 may comprise a CPU 200 and a memory 202. The CPU 200 can control the overall operation of the backplane controller 224. The CPU 200 may utilize the memory 202 during the performance of its processing functions. It should be appreciated that although the backplane controller 224 is described herein as a programmable microcontroller including a CPU 200 and memory 202, the embodiments presented herein may also be implemented utilizing a general purpose computer, a custom application specific integrated circuit (ASIC), a field-programmable gate array (FPGA) device, or any other type of IC or computing mechanism known to those skilled in the art.

According to various embodiments of the present invention, the backplane controller 224 may be equipped with multiple physical interfaces for communicating management data. For instance, the backplane controller 224 may include two or more SGPIO interfaces 204A, 204B for communicating management data with SAS-equipped HBAs or other types of SAS initiators. The SGPIO interfaces 204A, 204B can support four signals: serial data output (SDATAOUT), serial data input (SDATAIN), clock (SCLOCK), and a framing signal (SLOAD). Using these signals, the backplane controller 224 can receive information regarding the status of connected mass storage devices, such as data indicating whether a mass storage device is active, failed, hot-spare, or otherwise.

According to various embodiments of the present invention, the backplane controller 224 can provide an I2C interface 206 for communicating enclosure management data with a BMC or system management bus. The I2C interface 206 can support two signals: a serial clock line (SCL-UP), and a serial data line (SDA-UP). A downstream interface 208 may be provided for connecting to a downstream I2C device. According to various embodiments of the present invention, the HBA 200 may communicate with the backplane controller 224 over a private I2C bus. The SCSI enclosure services (SES) protocol is utilized for this communication. The I2C or

SGPIO bus can be routed to the enclosure management backplane 204 through a cable. The backplane controller 224 may also include circuitry for generating output signals to drive a visual or audible indicator. For instance, an output module 210 may be provided for illuminating LEDs or other types of activity indicators when one or more of the connected hard disk drives are active. An output module 212 may also be provided for driving LEDs when one or more of the connected hard disk drives has failed. It should be appreciated that a separate output may be provided for driving an individual LED indicating the activity or failure of each hard disk drive.

According to various embodiments of the present invention, the backplane controller 224 may also provide circuitry 314 for driving indicators related to global activity and global failure. It should be appreciated that these outputs may be configured to either drive an LED directly or to connect to an upstream backplane controllers. In this manner, the activity and failure of drives connected to one backplane controller 224 may be communicated to one or more additional upstream backplane controllers 224. According to various embodiments of the present invention, the outputs of the output modules 210 and 212 may also be utilized as latch enables to drive external latches and thereby illuminate a larger quantity of LEDs or other indicators.

The backplane controller 224 can provide an input 220 for receiving an appropriate voltage for powering the operation of the backplane controller 224. This voltage may typically be 5 volts or 3.3 volts according to various embodiments of the present invention. A ground connection 222 may also be provided as a power return. The backplane controller 224 may provide inputs 228A, 228B for receiving an appropriate clock signal, an input 244 for enabling a configuration of the IC 224, and a reset input 246 for resetting operation of the backplane controller 224.

The backplane controller 224 may provide one or more pins 227A-227H connected to a drive presence circuit 216. The drive presence circuit 216 may be configured to detect the presence of a mass storage device. According to various embodiments of the present invention, the drive presence circuit 216 may comprise an analog-to-digital converter (ADC) for detecting the voltage on the pins 227A-227H. Based on the detected voltage, the drive presence circuit 216 may determine whether a mass storage device has been connected. Each of the pins 227A-227H may be utilized to convey information regarding the mated status of a single respective mass storage device. According to various embodiments of the present invention, the drive presence circuit 216 may comprise one or more comparators configured to detect the voltage on the pins 227A-227H.

According to various embodiments of the present invention, the pins 227A-227H and the drive presence circuit 216 may be configured to detect the activity of a mass storage device. In this regard, the backplane controller 224 may be configured to determine, based on the voltage detected at each of the pins 227A-227H, whether a mass storage device associated with each of the pins 227A-227H is active. In this manner, a single one of the pins 227A-227H of the backplane controller 224 can be utilized to determine the mated status of a mass storage device and whether a connected mass storage device is active or inactive. The backplane controller 224 may transmit data regarding the mated status of each mass storage device to an HBA 100 via the SGPIO interfaces 204A, 204B or the I2C interface 206. The backplane controller 224 may also utilize the detected activity information to directly drive LEDs corresponding to active mass storage devices.

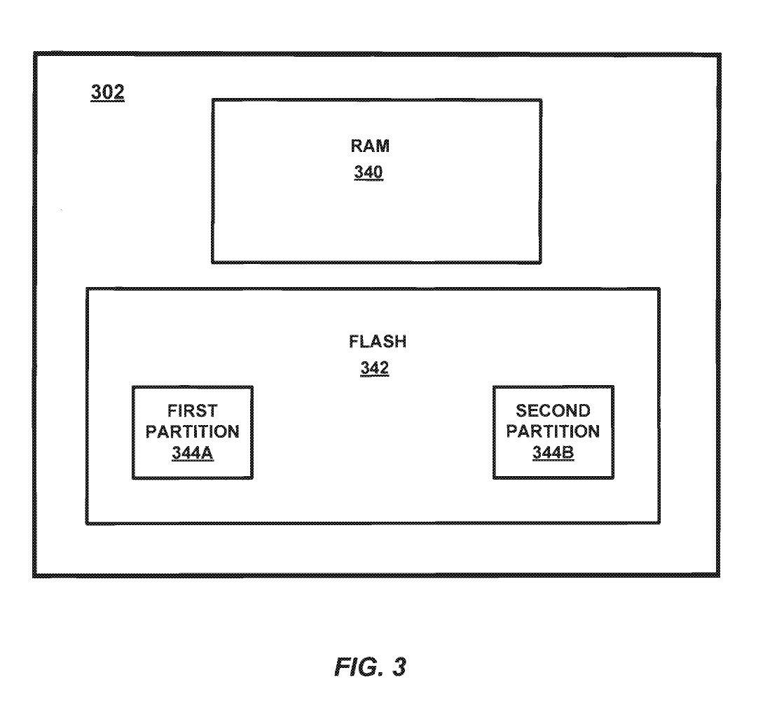

Now also referring to FIG. 3, in one aspect, the present invention relates to a microcontroller. According to one embodiment, the microcontroller, such as microcontroller 124 shown in FIG. 1 and microcontroller 224 shown in FIG. 2, includes a system memory such as system memory 202 shown in FIG. 2 and system memory 302 shown in FIG. 3. As shown in FIG. 3, the system memory 302 has an erasable memory of a first type 342 with a first storage partition 344A and a second, different storage partition 344B, as well as a random access memory (RAM) 340. The microcontroller 124, 224 further includes a network interface, such as network interface 132 shown in FIG. 1 and network interface 208 shown in FIG. 2, that is configured to communicate management commands over a communications link 134. A programmable processor such as central processing unit 200 in FIG. 2 is operatively connected to the system memory 202, 302 and the network interface 132, 208. The communications link 134 has an interface bus and is configured for one or more of I2C, SPI, and/or system management bus communications. The programmable processor 200 is programmed to perform functions that include receiving a first management command configured for the erasable memory of the first type 342, causing the second storage partition 344B of the erasable memory of the first type 342 to emulate a second type of erasable memory, and receiving a second management command configured for the second type of erasable memory.

In one embodiment, the programmable processor 200 is further programmed to respond to the first management command and/or second management command and to send a respective response over the communications link 134, via the network interface 132, 208. In one embodiment, the system memory 202, 302, network interface 132, 208, and programmable processor 200 are operatively coupled to a storage backplane such as storage backplane 104 shown in FIG. 1, and the network interface 132, 208 is communicatively connected to a management controller such as baseboard management controller (BMC) 106 shown in FIG. 1 that is operative to generate the first management command and the second management command. The management controller 106 is further operative to transmit the generated first management command and second management command to the programmable processor 200, and to receive a response from the programmable processor 200 in response to the first management command and/or the second management command, over the communications link 134. In one embodiment, the erasable memory of the first type 342 is a flash memory and the second type of erasable memory is an EEPROM. In this embodiment, the second storage partition 344B of the erasable memory of the first type 342 is operative to store data configured for an EEPROM. In an alternative embodiment, the second type of erasable memory is a SPI flash device and the second storage partition 344B of the erasable memory of the first type 342 is operative to store data configured for an SPI flash device. In still further alternative embodiments, the second type of erasable memory is a PROM or EPROM.

In one embodiment, the programmable processor 200 is programmed to, in response to a management command to write updated data to the second type of erasable memory, read out the data stored in the second storage partition 344B of the erasable memory of the first type 342 and write the read-out data into the RAM 340. The programmable processor 200 is also programmed to write the updated data into the RAM 300. Those skilled in the art will appreciate that the functions performed by the programmable processor 200 may be operational steps executed by the programmable processor 200 according to computer-executable instructions stored on a computer-readable medium, such as a hard disk drive 106 as shown in FIG. 1.

In one embodiment, the programmable processor 200 is programmed to read out the data from the RAM 340 and write the read-out data into the second storage partition 344B of the erasable memory of the first type 342, such as to replace previously stored data.

In one embodiment, the programmable processor 200 is programmed to, in response to a received management command to read data from the second type of erasable memory, read the data stored in the RAM 340 that includes the updated data.

In another aspect, the present invention relates to a microcontroller such as microcontroller 124 shown in FIG. 1 and microcontroller 224 shown in FIG. 2, operating as a backplane controller for a storage backplane such as storage backplane 104 shown in FIG. 1. In one embodiment, the microcontroller 224 is in a system that includes a baseboard with a baseboard management controller (BMC) such as BMC 106 and a storage backplane 104. The BMC 106 is communicatively connected to the storage backplane 104 via a communications link such as communications link 134 shown in FIG. 1 and is operative to communicate management commands over the communications link 134. In one embodiment, the communications link 134 has an interface bus and is configured for one or more of I2C, SPI, and system management bus communications. The management commands are configured for an erasable memory of a first type 342 and are also configured for a second, different type of erasable memory. According to one embodiment, the microcontroller 124, 224 includes a system memory, such as system memory 202 in FIG. 2 and system memory 302 in FIG. 3, that has an erasable memory of a first type, such as erasable memory 342 shown in FIG. 3. The erasable memory of the first type 342 has a first storage partition 344A and a second, different storage partition 344B. The system memory 202, 302 also includes a RAM 340. In this embodiment, the microcontroller 124, 224 further includes a network interface such as network interface 132 shown in FIG. 1 and network interface 208 shown in FIG. 2 that is operative to receive management commands from the BMC 106 and send responses to the management commands to the BMC 106 over the communications link 134. The microcontroller 124, 224 further includes a programmable processor such as central processing unit 200 shown in FIG. 2 that is operatively connected to the system memory 202, 302 and the network interface 132, 208. The programmable processor 200 is programmed to perform functions that include receiving a first management command from the BMC 106 over the communications link 134. The first management command is configured for the erasable memory of the first type 342. The programmable processor 200 is further programmed to perform the function of causing the second storage partition 344B of the erasable memory of the first type 342 to emulate the second type of erasable memory, and the function of receiving a second management command from the BMC 106 over the communications link 106. The second management command is configured for the second type of erasable memory.

In one embodiment, the programmable processor 200 is further programmed to generate a response to the first management command and/or the second management command, and to send the respective response to the BMC 106 over the communications link 134, via the network interface 132, 208.

In one embodiment, the system memory 202, 302, network interface 132, 208, and programmable processor 200 are operatively coupled to the storage backplane 104.

In one embodiment, the BMC 106 is operative to generate the management commands, transmit the first management command and second management command to the programmable processor 200, and receive a response from the programmable processor 200 in response to at least one of the first management command and the second management command, over the communications link 134.

In one embodiment, the programmable processor 200 is programmed to perform the function of, in response to a management command to write updated data to the second type of erasable memory, reading out the data stored in the second storage partition 344B of the erasable memory of the first type 342 and writing the read-out data into the RAM 340. The programmable processor 200 is programmed to perform the function of writing the updated data into the RAM 340.

In one embodiment, the programmable processor 200 is programmed to perform the function of reading out the data from the RAM 340, and the function or writing the read-out data into the second storage partition 344B of the erasable memory of the first type 342, such as to replace previously stored data.

In one embodiment, the programmable processor 200 is programmed to perform the function of, in response to a received management command to read data from the second type of erasable memory, reading the data stored in the RAM 340 including the updated data.

In yet another aspect, the present invention relates to a computer-readable medium. According to one embodiment, instructions are stored on the computer-readable medium. The instructions, when executed by a programmable processor such as central processing unit 200 shown in FIG. 2 of a microcontroller such as microcontroller 124 in FIG. 1 and backplane controller 224 in FIG. 2 that includes a network interface such as network interface 132 in FIG. 1 and network interface 208 in FIG. 2 that is configured to communicate management commands over a communications link such as communications link 134 in FIG. 1, a system memory such as system memory 202 in FIG. 2 and system memory 302 in FIG. 3 with an erasable memory of a first type such as flash memory 342 in FIG. 3 having a first storage partition 344A and a second, different storage partition 344B, and a random access memory (RAM) 340, cause the microcontroller 124, 224 to perform functions that include receiving a first management command configured for the erasable memory of the first type 342, causing the second storage partition 344B of the erasable memory of the first type 342 to emulate the second type of erasable memory, and receiving a second management command configured for the second type of erasable memory.

In one embodiment, the instructions, when executed by the programmable processor 200, cause the microcontroller 124, 224 to generate a response to at least one of the first management command and second management command and send the respective response over the communications link 134, via the network interface 132, 208.

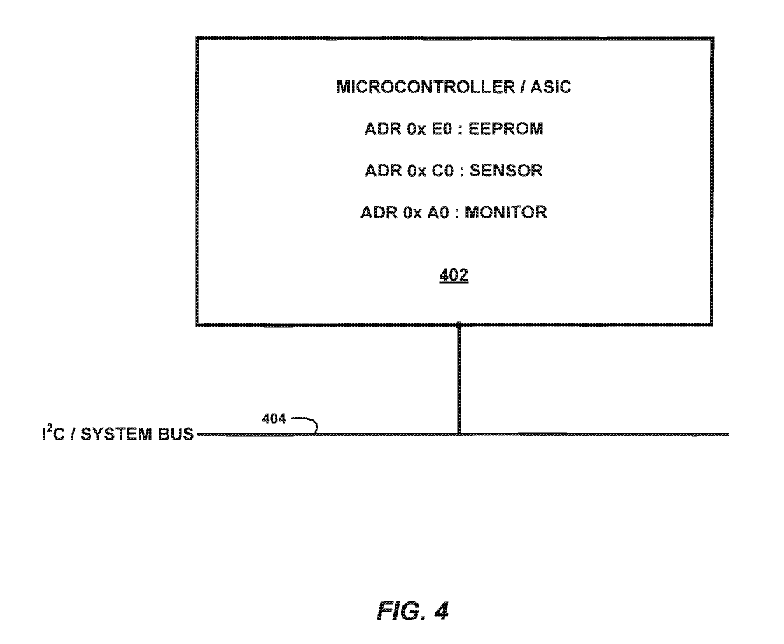

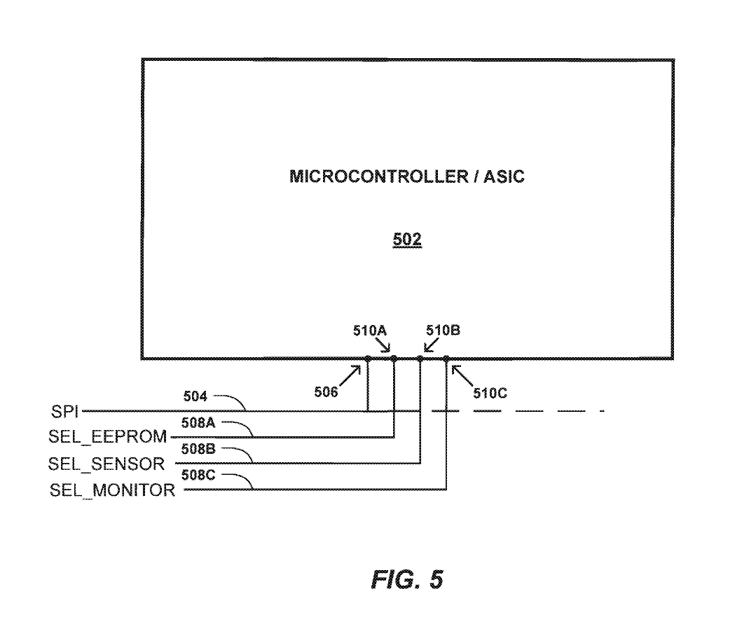

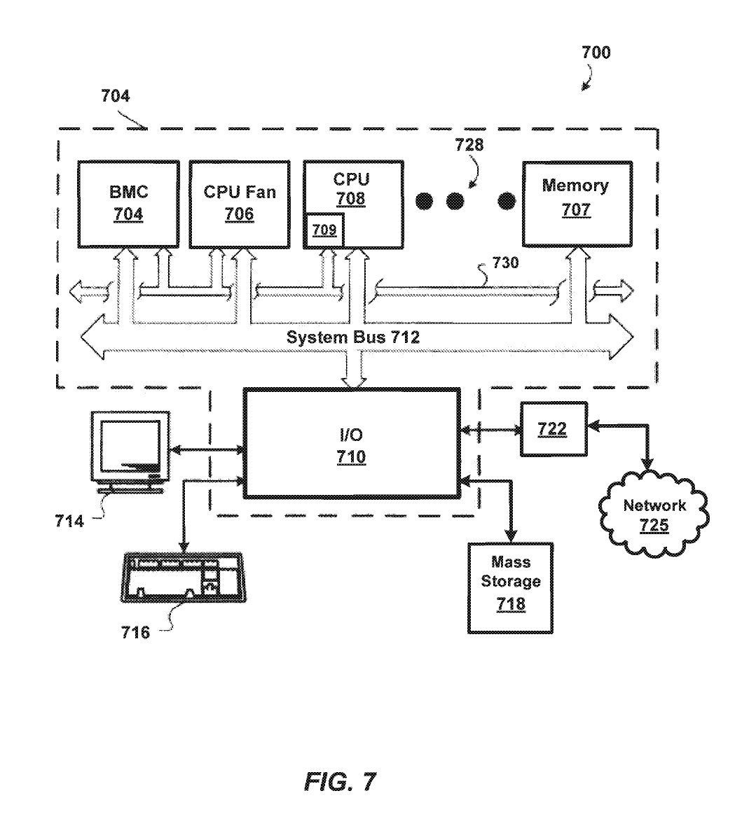

Now referring to FIGS. 4 and 5, in yet another aspect, the present invention relates to a microcontroller or application-specific integrated circuit (ASIC) that is operative to emulate communications addressed to and/or from an emulated component such as an emulated PROM, EPROM, or EEPROM. As shown in FIG. 4, in one embodiment, one or more of sensor and monitor components such as those referenced below with respect to the computing environment shown in FIG. 7 have associated addresses 0 x C0 and 0 x A0, respectively. In addition to communicating commands and/or performance-related data with the one or more sensors and/or monitors, the microcontroller/ASIC 402 is operative to emulate communication with an EEPROM having an address of 0 x E0, over a communication bus such as an I2C/system bus 404, wherein the EEPROM is emulated in flash memory of the microcontroller/ASIC 402. As shown in FIG. 5, in one embodiment, a microcontroller/ASIC 502 is communicatively connected to an SPI communication link 504 and pins 510A, 510B, and 510C are communicatively connected to communication links 508A, 508B, and 508C for performing functions in association with an emulated EEPROM, a sensor, and a monitor, respectively.

As may be further described below with reference to the computing environment shown in FIG. 7, it should be appreciated that according to various embodiments of the present invention, the microcontroller/ASIC may reside on an I2C or system management bus, performing a function as an I2C master or slave device, such as the function of a backplane controller or satellite controller, and may be configured to respond to a single address than additionally respond to a second address on the I2C/SMBus, where an EEPROM is emulated. Also, a microcontroller according to various embodiments of the present invention may be operative for both I2C/system management bus and SPI communication capabilities and, accordingly, configured to emulate functions of an SPI flash device and/or an I2C EEPROM device. In one or more embodiments wherein functions of both I2C and EEPROM are emulated, areas of flash memory that are accessible to multiple interfaces may be configured to partially or fully overlap, through corresponding programming and/or pin configuration.

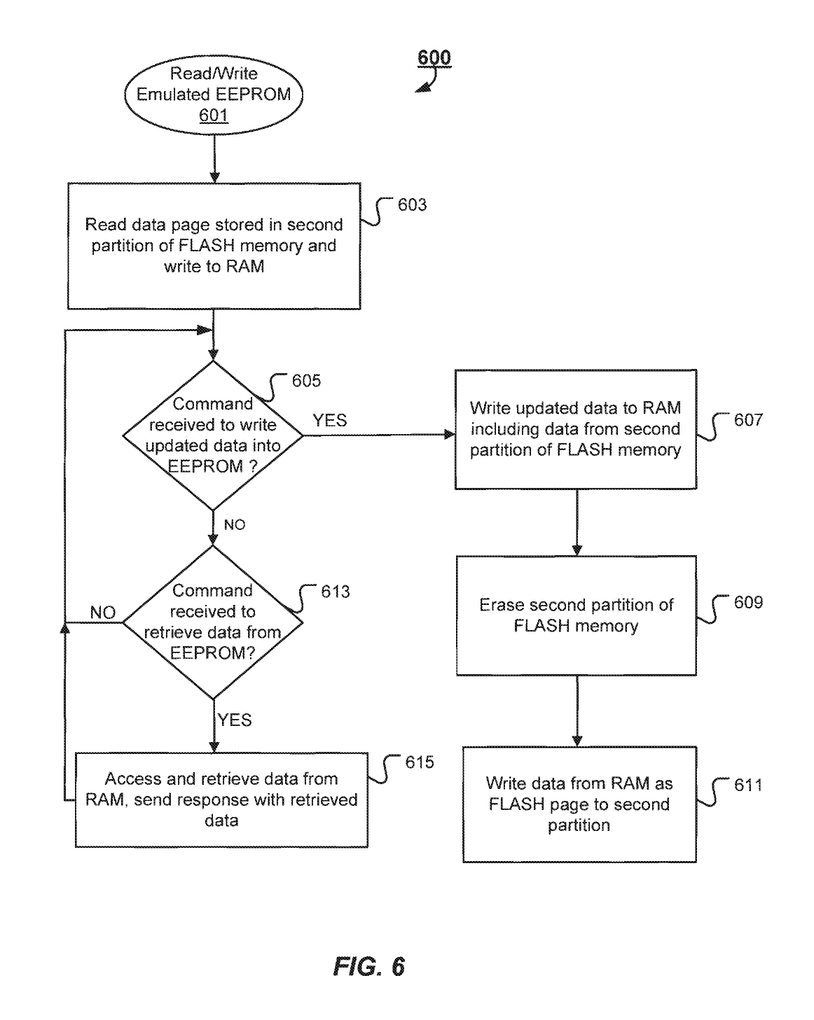

FIG. 6 is a flow chart illustrating operational steps of a computer-implemented method 600 for performing a read and/or write command to an emulated EEPROM, for example an emulated EEPROM in the second storage partition 344B shown in FIG. 3. Those skilled in the art will appreciate that the operational steps may be performed by a programmable processor such as programmable processor 200 in FIG. 2, of a computing device such as the microcontroller 124, 224 shown in FIGS. 1 and 2. Further, a computer-readable storage medium may have stored instructions that, when executed by a programmable processor, perform the operational steps of the method. As shown, the method for performing a read and/or write command to an emulated EEPROM begins at 601, and then at step 603 a flashed page of data stored in the second storage partition 344B is read out and then written to RAM 340. From step 603, as shown at step 605 if a management command is received to write updated into an EEPROM, then operational flow proceeds along the “Yes” path from step 605 to step 607. At step 607, updated data that includes data read from the second partition 344B of the erasable memory of the first type 342, here flash memory, is written to the RAM 340. Next, at step 609, the second partition 344B is erased, and then at step 611, the data from the RAM 340 is written to the second partition 344B of the flash memory 342 as a flash page of data. If a management command to write updated data is not received at step 605, then operational flow proceeds along the “No” path from step 605 to step 613, where, if a management command is received to retrieve data from an EEPROM, then operational flow proceeds along the “Yes” path from step 613 to step 615. At step 615, data from the RAM is accessed and retrieved, and the retrieved data is sent in response to the management command. As shown, from step 615, operational flow proceeds back to step 605. If a management command to retrieve data from an EEPROM is not received, then operational flow proceeds along the “No” path from step 613 back to step 605. Those skilled in the art will appreciate that although steps 605 and 613 are shown in sequential order in FIG. 3, other orders of operational steps are within the scope of the invention. For example, the operation performed at step 613 could proceed the operation performed at step 605 in an alternative embodiment. Further, in an alternative embodiment, the determination of whether a management command is received to write updated data into EEPROM and the determination of whether a management command is received to retrieve data from an EEPROM can be performed at one step, rather than having one determination be made first before proceeding to make the other determination.

As described above, those skilled in the art will appreciate that these logical operations may be stored on any type of computer readable medium, which may also be referred to as a “computer program product.” Exemplary forms of computer readable media include computer storage media. Computer storage media includes volatile and nonvolatile, removable and non-removable media implemented in any method or technology for storage of information such as computer readable instructions, data structures, program modules or other data. As such, exemplary forms of computer storage media includes, without limitation, read only and random access memory (ROM and RAM, respectively), solid state, non-volatile memory, EEPROM, flash memory or other memory technology, DVD or other optical storage, and CD-ROM.

The foregoing description of exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A microcontroller, comprising:
(a) a system memory, comprising:
(i) an erasable memory of a first type having a first storage partition and a second, different storage partition; and
(ii) a random access memory (RAM);
(b) a network interface configured to communicate management commands over a communications link; and
(c) a programmable processor operatively connected to the system memory and the network interface, programmed to perform functions comprising:
(i) receiving a first management command configured for the erasable memory of the first type;
(ii) causing the second storage partition of the erasable memory of the first type to emulate a second type of erasable memory; and
(iii) receiving a second management command configured for the second type of erasable memory.

2. The microcontroller of claim 1, wherein the programmable processor is further programmed to respond to at least one of the first management command and second management command and send the response over the communications link, via the network interface.

3. The microcontroller of claim 1, wherein the system memory, network interface, and programmable processor are operatively coupled to a storage backplane.

4. The microcontroller of claim 3, wherein the network interface is communicatively connected to a management controller that is operative to generate the first management command and the second management command, transmit the first management command and second management command to the programmable processor, and receive a response from the programmable processor in response to at least one of the first management command and the second management command, over the communications link.

5. The microcontroller of claim 1, wherein the erasable memory of the first type is a flash memory.

6. The microcontroller of claim 1, wherein the second type of erasable memory is an EEPROM and the second storage partition of the erasable memory of the first type is operative to store data configured for an EEPROM.

7. The microcontroller of claim 1, wherein the second type of erasable memory is a SPI flash device and the second storage partition of the erasable memory of the first type is operative to store data configured for an SPI flash device.

8. The microcontroller of claim 1, wherein the communications link comprises as interface bus and is configured for at least one of I2C, SPI, and system management bus communications.

9. The microcontroller of claim 1, wherein the functions performed by the programmable processor further comprise, in response to a management command to write updated data to the second type of erasable memory:
(a) reading out the data stored in the second storage partition of the erasable memory of the first type and writing the read-out data into the RAM; and
(b) writing the updated data into the RAM.

10. The microcontroller of claim 9, wherein the functions performed by the programmable processor further comprise reading out the data from the RAM and writing the read-out data into the second storage partition of the erasable memory of the first type such as to replace previously stored data.

11. The microcontroller of claim 9, wherein the functions performed by the programmable processor further comprise, in response to a received management command to read data from the second type of erasable memory, reading the data stored in the RAM including the updated data.

12. In a system having a baseboard with a baseboard management controller (BMC) and a storage backplane, wherein the BMC is communicatively connected to the storage backplane via a communications link and is operative to communicate management commands configured for a first type of erasable memory and a second, different type of erasable memory, over the communications link, a microcontroller, as a backplane controller, comprising:
(a) a system memory, comprising:
(i) an erasable memory of the first type having a first storage partition and a second, different storage partition; and
(ii) a random access memory (RAM);
(b) a network interface operative to receive management commands from the BMC and send responses to the management commands to the BMC over the communications link; and
(c) a programmable processor operatively connected to the system memory and the network interface, programmed to perform functions comprising:
(i) receiving a first management command from the BMC over the communications link, the command configured for the erasable memory of the first type;
(ii) causing the second storage partition of the erasable memory of the first type to emulate the second type of erasable memory; and
(iii) receiving a second management command from the BMC over the communications link, the command configured for the second type of erasable memory.

13. The microcontroller of claim 12, wherein the functions performed by the programmable processor further include generating a response to at least one of the first management command and second management command, and sending the response to the BMC over the communications link, via the network interface.

14. The microcontroller of claim 12, wherein the system memory, network interface, and programmable processor are operatively coupled to the storage backplane.

15. The microcontroller of claim 14, wherein the BMC is operative to generate the management commands, transmit the first management command and second management command to the programmable processor, and receive a response from the programmable processor in response to at least one of the first management command and the second management command, over the communications link.

16. The microcontroller of claim 12, wherein the functions performed by the programmable processor further comprise, in response to a management command to write updated data to the second type of erasable memory:
(a) reading out the data stored in the second storage partition of the erasable memory of the first type and writing the read-out data into the RAM; and
(b) writing the updated data into the RAM.

17. The microcontroller of claim 16, wherein the functions performed by the programmable processor further comprise reading out the data from the RAM and writing the read-out data into the second storage partition of the erasable memory of the first type such as to replace previously stored data.

18. The microcontroller of claim 16, wherein the functions performed by the programmable processor further comprise, in response to a received management command to read data from the second type of erasable memory, reading the data stored in the RAM including the updated data.

19. A computer-readable medium having instructions stored thereon which, when executed by a programmable processor of a microcontroller that has a network interface configured to communicate management commands over a communications link, a system memory with an erasable memory of a first type having a first storage partition and a second, different storage partition, and a random access memory (RAM), cause the microcontroller to perform functions comprising:
(a) receiving a first management command configured for the erasable memory of the first type;
(b) causing the second storage partition of the erasable memory of the first type to emulate the second type of erasable memory; and
(c) receiving a second management command configured for the second type of erasable memory.

20. The computer-readable medium of claim 19, wherein the instructions, when executed by the programmable processor, cause the microcontroller to generate a response to at least one of the first management command and second management command and send the respective response over the communications link, via the network interface.
